(19) United States
(12) Patent Application Publication
(10) Pub. No.: US 2007/0207922 A1
(43) Pub. Date: Sep. 6, 2007

(54) METHOD FOR FINISHING ABSORBENT MATERIALS

(75) Inventors: Corinna Haindl, Mannheim (DE); Cedric Dieleman, Scheibenhard (FR); Axel Ebenau, Limburgerhof (DE); Harald Keller, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/572,636

(22) PCT Filed: Jul. 30, 2005
(86) PCT No.: PCT/EP05/08277

§ 371 Date: Jan. 25, 2007

(30) Foreign Application Priority Data
Aug. 5, 2004 (DE) 10 2004 038 218.2

(51) Int. Cl. B01J 20/00

(52) U.S. Cl. 502/400

(57) ABSTRACT

A process for finishing absorbent material which comprises it being (A) hydrophilicized in a first step (B) treated in a subsequent step with at least one aqueous liquor comprising (a) at least one organic polymer, (b) at least one organic or inorganic solid in particulate form other than (a), and (c) at least one emulsifier.

A process for finishing absorbent material, which comprises it being

(A) hydrophilicized in a first step

(B) treated in a subsequent step with at least one aqueous liquor comprising

(a) at least one organic polymer,
(b) at least one organic or inorganic solid in particulate form other than (a), and
(c) at least one emulsifier.

The finishing of textiles is a field of growing commercial importance. It is particularly interesting to finish textiles so as to render them water and soil repellent. Modern measures utilize in some cases the so-called Lotus-Effekt® and confer water-repellent performance on textiles by applying a rough surface.

WO 96/04123 describes self-cleaning surfaces which have an artificial surface structure which has elevations and depressions, the structure being characterized by its structural parameters in particular. The structures are prepared for example by embossing a structure onto a thermoplastically formable hydrophobic material or by applying Teflon powder to a surface which has been treated with UHU®. U.S. Pat. No. 3,354,022 discloses similarly prepared water-repellent surfaces.

EP-A 0 933 388 discloses processes for preparing structured surfaces that comprise first preparing a negative mold by photolithography, using this mold to emboss a plastics film and then hydrophobicizing the embossed plastics film with fluorinated alkylsilanes.

However, the methods described above are unsuitable for soil- and water-repellent finishing of textiles.

WO 02/84013 proposes hydrophobicizing fibers, composed of polyester for example, by pulling them through a hot decalin bath at 80° C. in which 1% of Aerosil 8200 hydrophobicized silica gel has been suspended.

WO 02/84016 proposes hydrophobilcizing woven polyester fabric by pulling it through a bath of hot DMSO (dimethyl sulfoxide) at 50° C. in which 1% of Aeroperl 8200 hydrophobicized silica gel has been suspended.

The two hydrophobicization methods share the feature that the solvent is selected such that the fibers are partially dissolved. This requires using large amounts of organic solvent, and this is undesirable in many cases. Moreover, treatment with organic solvents can have an adverse effect on fiber-mechanical properties.

WO 01/75216 proposes rendering textile fibers and fabrics water and soil repellent by providing them with a two-component layer, of which one is a dispersion medium and the other is a colloid for example. The finishing process described in WO 01/75216 provides finishing layers in which the colloids are anisotropically dispersed in the dispersion medium in that the colloids are observed to become concentrated at the boundary layer between the finishing layer and the surrounding surface. The process utilizes finishing liquors which contain up to 5 g/l of Aerosil 812 S.

However, textiles finished by the process described in WO 01/75216 lack satisfactory mechanical strength in many cases.

It is also observed that prior art absorbent materials, and especially textiles, treated to be soil repellent often exhibit a high water uptake, as can be determined by the Bundesmann test for example, and this is undesirable for many applications.

The present invention therefore has for its object to provide a process for finishing absorbent materials which is free of the disadvantages indicated above and which at the same time provides a very good water- and soil-repellent performance. The present invention further has for its object to provide soil- and water-repellent textiles.

We have found that this object is achieved by the process defined at the beginning.

Absorbent materials for the purposes of the present invention include for example paper, board, wood, building materials such as for example tile, concrete, natural stone, sandstone and sand-lime brick, also leather substitutes and leather and preferably textile materials. Textile materials are, for example, fibers, roving, yarn, thread on the one hand and textile fabrics on the other such as for example wovens, knits, nonwovens and garments. Particular preference is given to textile fabrics used for manufacturing outdoor textiles for example. Examples are sails, umbrellas, tarpaulins, groundsheets, tablecloths, awnings, coverings for water vehicles such as for example sailboats and motorboats, and furniture covers for example for chairs, swings or benches.

Absorbent materials for the purposes of the present invention can consist of different substances. Examples are natural fibers and synthetic fibers and also blend fibers. Examples of natural fibers are silk, wool and more preferably cotton. Examples of synthetic fibers are polyamide, polyester, polypropylene, polyacrylonitrile and polyethylene terephthalate. Similarly, modified natural fibers can be coated according to the process of the present invention, for example cellulose acetate.

The process of the present invention comprises two steps with absorbent material being

(A) hydrophilicized in a first step

(B) treated in a subsequent step with at least one aqueous liquor comprising

(a) at least one organic polymer,
(b) at least one organic or inorganic solid in particulate form other than (a), and
(c) at least one emulsifier.

Further, optional steps may be carried out in certain embodiments of the present invention.

Step (A) comprises absorbent material being hydrophilicized. Hydrophilicizing is to be understood as meaning in the context of the present invention that the surface of absorbent material is treated such that, immediately following step (A), said absorbent material is wettable in by water. The wettability of the surface of absorbent material pretreated according to step (A) is detectable for example by the surface having a nonmeasurable contact angle with water under standard conditions. Preferably, on surfaces hydrophilicized as per step (A), water does not form droplets visible to the naked eye, but spreads to form a film.

In a preferred embodiment of the present invention, step (A) comprises hydrophilicizing and smoothing. Smoothing in the context of the present invention is to be understood as meaning that protruding fuzz, hairs and other material-based unevennesses of absorbent materials are removed or adhered to the actual surface such that, to the naked eye, they do not visibly protrude from the leveled plane.

Step (A) can be accomplished for example by contacting absorbent material in dry or preferably water-moistened form with one or more objects having a temperature of not less than 450° C. preferably of not less than 500° C. and more preferably of not less than 750° C. or with one or more flames. The upper limit for the contacting of absorbent material with one or more objects having a temperature of not less than 450° C. is 1300° C. and preferably 900° C.

The one or more objects having a temperature of not less than 450° C. may in one embodiment of the present invention be for example one or more objects having a planar or arcuate surface, for example one or more rolls one or more plungers or one or more plates.

The objects or objects used according to the present invention in step (A) as having a temperature of not less than 450° C. are preferably constructed such that that surface which is contacted with absorbent material consist of metal or an alloy, preferably of steel and more preferably of copper or a copper-containing alloy. It is very particularly preferable for at least one object used according to the present invention in step A) to be a glowing plate of copper.

In one embodiment of the present invention, absorbent material is contacted with one or more objects having a temperature of not less than 450° C. by leading absorbent material over said object or objects, which may be stationary or—in the case of rolls—may rotate. It is preferable to lead absorbent material over one or more objects having a temperature of not less than 450° C. at a linear speed in the range from 20 to 300 m/min and preferably in the range from 30 to 200 m/min.

In another embodiment of the present invention, absorbent material is contacted with one or more flames, for example with one or more gas flames and preferably with one or more nonluminous gas flames, the composition of the gas or gas mixture in question being as such not critical. The composition of the gas in question is preferably constant during step (A). The temperature of one or more flames is preferably in the range from 1100 to 1500° C. and more preferably in the range from 1200 to 1300° C.

A useful linear speed is for example up to 250 m/min and preferably in the range from 30 to 200 m/min.

Absorbent material can be contacted with one or more flames one or more times.

Another embodiment of step (A) comprises leading absorbent material past one or more hot ceramic bodies which have a temperature in the range from 800° C. to 1300° C. Ceramic bodies heated to such temperatures typically emit IR radiation for example. Useful apparatus wherein absorbent substrates and especially textile substrates can be led past hot ceramic bodies is commercially available.

It will be appreciated that various of the above-described embodiments of step (A) may be combined with each or one another. It is similarly possible to repeat one or more embodiments, for example by leading absorbent material over two rotating rolls having a temperature of 500° C.

Absorbent material to be treated may when it is of sheetlike construction be contacted on both sides or preferably on one side with one or more objects having a temperature of not less than 450° or with one or more flames.

Following above-described embodiments of step (A), absorbent material which has been contacted according to step (A) and especially by contacting with one or more objects having a temperature of not less than 450° C. or with one or more flames may be treated with water, for example as a bath, in the form of water-cooled rolls or in the form of water vapor, and thereby prevent flying sparks and burning of absorbent material.

The above-described embodiments of step (A) may be followed by treating with one or more fixed or rotating brushes.

In another embodiment of the present invention, absorbent material is treated and preferably coated in step (A) with at least one melt or preferably dispersion of at least one (co)polymer selected from anionic polyurethanes, copolymers of C₁-C₁₀-alkyl (meth)acrylates and copolymers of C₁-C₁₀-alkyl(meth)acrylates with at least one ethylenically unsaturated compound.

Dispersions preferably employed in step (A) are preferably aqueous dispersions for example having a solids content in the range from 30% to 60% by weight and preferably in the range from 40% to 55% by weight.

In one embodiment of the present invention, aqueous dispersion of (co)polymer preferably employed in step (A) has a dynamic viscosity in the range from 50 to 500 mPa·s and preferably in the range from 70 to 290 mPa·s, measured at 25° C.

Anionic polyurethanes for the purposes of the present invention are obtainable for example by reacting one or more aromatic or preferably aliphatic or cycloaliphatic diisocyanates with one or more polyesterdiols.

Useful aromatic diisocyanates include for example 2,4′-tolylene diisocyanate and 2,4-diphenylmethane diisocyanate (2,4′-MDI). Useful aliphatic diisocyanates include for example hexamethylene diisocyanate and dodecamethylene diisocyanate.

Useful cycloaliphatic diisocyanates include for example 2,4′-methylenebis(cyclohexyl) diisocyanate, 4-methylcyclohexane 1,3-diisocyanate (H-TDI), isophorone diisocyanate (IPDI) and bis-4,4′-cyclohexylmethylene diisocyanate.

Useful polyesterpolyols are obtainable by polycondensation of one or more preferably aliphatic or cycloaliphatic diols and one or more aromatic or preferably aliphatic dicarboxylic acids.

Useful aliphatic diols include for example ethylene glycol, 1,3-propanediol, 1,4-butanediol, 1,6-hexanediol, 1,12-dodecanediol, propylene glycol (1,2-propanediol), butylene glycol (1,2-butanediol), neopentylglycol.

Useful cycloaliphatic diols include for example cis-1,4-cyclohexanedimethanol, trans-1,4-cyclohexanedimethanol, cis-1,3-cyclohexanedimethanol, trans-1,3-cyclo-hexanedimethanol.

Useful aromatic dicarboxylic acids include for example terephthalic acid, phthalic acid and especially isophthalic acid.

Useful aliphatic dicarboxylic acids include for example succinic acid, glutaric acid and especially adipic acid.

Very particularly useful polyesterpolyols are obtainable for example by polycondensation of two or more different aliphatic or cycloaliphatic diols with at least one aromatic or preferably aliphatic dicarboxylic acid, for example from isophthalic acid, adipic acid and 1,4-cyclohexanedimethanol or from adipic acid, neopentylglycol and 1,6-hexanediol.

In one embodiment of the present invention, particularly useful polyesterpolyols have an acid number in the range from 10 to 200 mg of KOH/g of polyesterpolyol, determined according to German standard specification DIN 53402.

In another embodiment of the present invention, particularly useful polyesterpolyols have a hydroxyl number in the range from 10 to 200 mg of KOH/g of polyesterpolyol, determined according to German standard specification DIN 53240.

(Co)polymers of C₁-C₁₀-alkyl(meth)acrylates and copolymers of C₁-C₁₀-alkyl (meth)acrylates with at least one ethylenically unsaturated compound include for example block copolymers and preferably random copolymers comprising interpolymerized units of the following comonomers:

from 40% to 95% by weight and preferably from 50% to 90% by weight of one or more C₁-C₁₀-alkyl(meth)acrylates, preferably C₄-C₈-alkyl(meth)acrylates, examples being methyl(meth)acrylate, ethyl(meth)acrylate, n-propyl(meth)acrylate, isopropyl (meth)acrylate, n-decyl(meth)acrylate, preferably n-butyl(meth)acrylate, isobutyl (meth)acrylate, n-hexyl(meth)acrylate, n-octyl(meth)acrylate, 2-ethylhexyl (meth)acrylate, more preferably n-butyl(meth)acrylate, and 2-ethylhexyl (meth)acrylate,

from 0.1% to 10% by weight and preferably from 1% to 5% by weight of one or more ethylenically unsaturated carboxylic acids, for example methacrylic acid or especially acrylic acid,

from 0% to 50% by weight and preferably from 1% to 40% by weight of at least one further ethylenically unsaturated compound selected from vinylaromatic compounds such as for example α-methylstyrene, para-methylstyrene, para-n-butylstyrene and especially styrene,

(meth)acrylonitrile,

N-methylol(meth)acrylamide,

vinyl esters of aliphatic carboxylic acids, examples being vinyl propionate and especially vinyl acetate.

In a preferred embodiment of the present invention, copolymer in step (A) is constructed of

from 40% to 95% by weight and preferably from 50% to 90% by weight of at least one C₁-C₁₀-alkyl(meth)acrylate, preferably ethyl acrylate, n-butyl acrylate and/or 2-ethylhexyl acrylate,

from 0.1% to 10% by weight and preferably from 1% to 5% by weight of methacrylic acid or especially acrylic acid, and

from 0% to 50% by weight and preferably from 1% to 40% by weight of at least one ethylenically unsaturated compound, especially styrene, vinyl acetate or (meth)acrylonitrile.

In one embodiment of the present invention, a (co)polymer is a self-crosslinking (co)polymer, for example of one or more C₁-C₁₀-alkyl(meth)acrylates with acrylic acid and N-methylol(meth)acrylamide.

In a specific embodiment of the present invention, absorbent material is treated in step (A) with a mixture of at least two (co)polymers comprising from 40% to 99.9% by weight of a thermally crosslinkable (co)polymer of C₁-C₁₀-alkyl(meth)acrylates with (meth)acrylic acid and optionally further ethylenically unsaturated compounds, and from 0.1% to 60% by weight of anionic polyurethane, all weight % ages being based on the total weight of the melt in question or on the solids content of the dispersion in question.

The contacting with at least one melt or preferably dispersion of at least one (co)polymer in step (A) can utilize for example conventional techniques of coating or finishing paper and especially textiles, preferably printing, applying and especially knifecoating.

In one embodiment of the present invention, step (A) is implemented by applying and especially knifecoating at least one (co)polymer in a layer thickness from 10 to 500 μm and preferably from 50 to 300 μm atop absorbent material.

In one embodiment of the present invention, step (A) is implemented by applying at least one copolymer atop absorbent material in the range from 5 to 100 g/m² and preferably from 8 to 60 g/m².

If, in step (A), it is desired to treat with at least one (co)polymer in the form of a dispersion, which can be present as an emulsion or suspension for example, such a dispersion may comprise further ingredients, for example defoamers, biocides, thickeners, buffers, binders and emulsifiers.

Useful defoamers include for example up to 50-tuply alkoxylated, preferably ethoxylated or propoxylated, polysiloxanes having from 3 to 10 silicon atoms per molecule, especially alkoxylated 2-(3-hydroxypropyl)heptamethyltrisiloxanes which comprise up to 50 ethylene oxide and/or propylene oxide units per mole and preferably comprise a block of 7 to 20 and preferably 7 to 12 ethylene oxide units and a block of 2 to 20 and preferably 2 to 10 propylene oxide units.

Useful biocides include for example fungicides, especially 1,2-benzisothiazolin-3-one (commercially available as Proxel brands from Avecia Lim.) and its alkali metal salts, also glutaraldehyde, tetramethylolacetylenediurea, 2-methoxycarbonylamino-benzimidazole.

As thickeners there may be mentioned thickeners of natural or synthetic origin. Useful synthetic thickeners include poly(meth)acrylic compounds, polycarboxylic acids, polyethers, polyimines, polyamides and polyurethanes, especially copolymers comprising from 85% to 95% by weight of acrylic acid, from 4% to 15% by weight of acrylamide and about 0.01%-1% by weight of the (meth)acrylamide derivative of the formula V 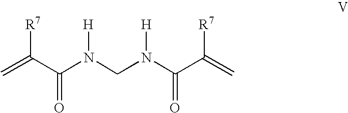
having molecular weights M_{w} in the range from 100 000 to 200 000 g/mol, in each of which R⁷ represents methyl or preferably hydrogen. Thickeners of natural origin include for example agar, carrageenan, modified starch and modified cellulose.

Useful buffers include for example ammonia/ammonium halide buffer, acetic acid/acetate buffer and citric acid/citrate buffer.

Useful emulsifiers include for example one- to 50-tuply alkoxylated, especially ethoxylated, n-C₁₀-C₃₀-alkanols and one- to 50-tuply alkoxylated, especially ethoxylated, alkylphenols.

Useful binders include for example melamine-formaldehyde condensation products, for example of melamine with preferably up to 6 equivalents of formaldehyde, and urea-glyoxal-formaldehyde condensation products of glyoxal with urea and 2 equivalents of formaldehyde.

One embodiment of the present invention comprises adding, as well as binder, one or more crosslinking catalysts as an ingredient, for example Zn(NO₃)₂ or MgCl₂, for example in the form of their hydrates, or NH₄Cl.

In one embodiment of the present invention, the total amount of aforementioned further ingredients is in the range from 0.5% to 20% by weight, based on melt or preferably dispersion used in step (A), preferably in the range from 1% to 10% by weight.

The treating of absorbent material with at least one melt or preferably dispersion of at Test one (co)polymer in step (A) may be followed by a thermal treatment, for example for a period in the range from 10 seconds to 60 minutes and preferably from 0.5 minute to 7 minutes at temperatures in the range from 50 to 300° C., preferably from 100 to 160° C. and more preferably from 110 to 130° C., Polyamide, polyester, polyvinyl chloride, modified polyesters, polyester blend fabrics, polyamide blend fabrics, polyacrylonitrile, cotton are advantageously treated thermally at temperatures in the range from 130 to 250° C. Polypropylene fabrics preferably between 80 and 130° C., preferably 110 and 130° C. Temperature here refers in general to the temperature of the medium such as for example air surrounding the flexible substrate to be treated.

One specific version comprises combining two steps (A). For example, absorbent material may initially be contacted with one or more objects having a temperature of not less than 450° C. or with one or more flames and then with at least one melt or preferably dispersion of at least one (co)polymer selected from anionic polyurethanes, copolymers of C₁-C₁₀-alkyl(meth)acrylates and copolymers of C₁-C₁₀-alkyl (meth)acrylates with at least one ethylenically unsaturated compound. Similarly, absorbent material may initially be treated with at least one melt or preferably dispersion of at least one (co)polymer selected from anionic polyurethanes, copolymers of C₁-C₁₀-alkyl(meth)acrylates and copolymers of C₁-C₁₀-alkyl(meth)acrylates with at least one ethylenically saturated or unsaturated compound and then be contacted with one or more objects having a temperature of not less than 450° C. or with one or more flames.

Absorbent material which has been treated according to step (A) will hereinafter also be referred to as pretreated absorbent material.

The process of the present invention is further carried out by treating pretreated absorbent material, in a step (B) following step (A), with at least one aqueous liquor comprising

(a) at least one organic polymer,

(b) at least one organic or inorganic solid in particulate form, and

(c) at least one emulsifier.

Aqueous liquor for the purposes of the present invention refers to such liquors as may comprise not less than 5% by weight of water, based on fractions which are liquid at room temperature. The water content of aqueous liquors is preferably not less than 25% by weight, more preferably not less than 50% by weight and most preferably not less than 75% by weight. The maximum water content, based on fractions which are liquid at room temperature, is 100% by weight, preferably 97% by weight and more preferably 95% by weight.

Aqueous liquors used in the present invention may comprise organic solvents, examples being methanol, ethanol, isopropanol, acetone, methyl ethyl ketone, methyl isobutyl ketone, ethylene glycol mono-n-butyl ether, ethylene glycol monoisobutyl ether, acetic acid, n-butanol, isobutanol, n-hexanol and isomers, n-octanol and isomers, n-dodecanol and isomers, as well as water. Organic solvents may comprise from 0.2% to 50% by weight and preferably from 0.5% to 35% by weight of the aqueous liquor used according to the present invention. Aqueous liquors having a water content of 100% by weight, based on fractions liquid at room temperature, accordingly comprise no organic solvents.

At least one of the liquors used in the process of the present invention comprises at least one organic polymer (a). Organic polymers (a) can serve as a binder. The action of a binder can be brought about for example by the organic polymer (a) forming a film which binds the particles to each other and to the absorbent and preferably textile material to be coated.

In one embodiment of the present invention, at least one organic polymer (a) comprises polymers or copolymers of ethylenically unsaturated hydrophobic monomers which have a 25° C. solubility in water of less than 1 g/l. In copolymers, hydrophobic monomers account for at least 50% by weight and preferably at least 75% by weight of the copolymer.

Preferred monomers are selected from the groups of the

C₂-C₂₄-olefins, especially α-olefins of 2 to 24 carbon atoms, for example ethylene, propylene, 1-butene, isobutene, 1-hexene, 1-octene, 1-decene, 1-dodecene, 1-hexadecene or 1-octadecene;

vinyl aromatics, for example styrene, α-methylstyrene, cis-stilbene, trans-stilbene, diolefins such as for example 1,3-butadiene, cyclopentadiene, chloroprene or isoprene, C₅-C₁₈-cycloolefins such as for example cyclopentene, cyclohexene, norbornene, dimeric cyclopentadiene,

vinyl esters of linear or branched C₁-C₂₀-alkanecarboxylic acids such as for example vinyl acetate, vinyl propionate, vinyl n-butyrate, vinyl n-hexanoate, vinyl n-octanoate, vinyl laurate and vinyl stearate,

(meth)acrylic esters of C₁-C₂₀-alcohols, for example methyl(meth)acrylate, ethyl (meth)acrylate, n-propyl(meth)acylate, isopropyl(meth)acrylate, n-butyl (meth)acrylate, isobutyl(meth)acrylate, tert-butyl(meth)acrylate, 2-ethylhexyl (meth)acrylate, n-octyl(meth)acrylate, n-decyl(meth)acrylate, n-dodecyl (meth)acrylate, n-eicosyl(meth)acrylate

and most preferably from the groups of the halogenated monomers and the monomers having siloxane groups.

Halogenated monomers include chlorinated olefins such as for example vinyl chloride and vinylidene chloride.

Most particularly preferred halogenated monomers are fluorous olefins such as for example vinylidene fluoride, trifluorochloroethylene, tetrafluoroethylene, hexafluoropropylene, vinyl esters of fluorinated or perfluorinated C₃-C₁₁-carboxylic acids as described for example in U.S. Pat. No. 2,592,069 and U.S. Pat. No. 2,732,370 (meth)acrylic esters of fluorinated or perfluorinated alcohols such as for example fluorinated or perfluorinated C₃-C₁₄-alkyl alcohols, for example (meth)acrylate esters of HO—CH₂—CH₂—CF₃, HO—CH₂—CH₂—C₂F₅, HO—CH₂—CH₂-n-C₃F₇, HO—CH₂—CH₂-iso-C₃F₇, HO—CH₂—CH₂-n-C₄F₉, HO—CH₂—CH₂-n-C₆F₁₃, HO—CH₂—CH₂-n-C₈F₁₇, HO—CH₂—CH₂-n-C₁₀F₂₁, HO—CH₂—CH₂-n-C₁₂F₂₅,

described for example in U.S. Pat. No. 2,642,416, U.S. Pat. No. 3,239,557, BR 1,118,007, U.S. Pat. No. 3,462,296.

Similarly, copolymers of for example glycidyl(meth)acrylate with esters of the formula III 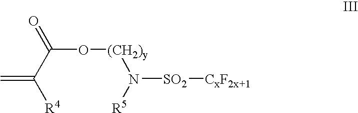
where:
R⁴ is hydrogen, CH₃, C₂H₅,
R⁵ is CH₃, C₂H₅,
x is an integer from 4 to 12 and most preferably from 6 to 8
y is an integer from 1 to 11 and preferably from 1 to 6,
or glycidyl(meth)acrylate with vinyl esters of fluorinated carboxylic acids are suitable.

Useful copolymers further include copolymers of (meth)acrylic esters of fluorinated or perfluorinated C₃-C₂-alkyl alcohols such as for example HO—CH₂—CH₂—CF₃, HO—CH₂—CH₂—C₂F₅, HO—CH₂—CH₂-n-C₃F₇, HO—CH₂—CH₂-iso-C₃F₇, HO—CH₂—CH₂-n-C₄F₉, HO—CH₂—CH₂-n-C₅F₁₁, HO—CH₂—CH₂-n-C₆F₁₃, HO—CH₂—CH₂-n-C₇F₁₅;

with (meth acrylic esters of nonhalogenated C₁-C₂₀ alcohols, for example methyl (meth)acrylate, ethyl(meth)acrylate, n-butyl(meth)acrylate, n-propyl(meth)acrylate, 2-ethylhexyl(meth)acrylate, n-octyl(meth)acrylate, n-decyl(meth)acrylate, n-dodecyl (meth)acrylate, n-eicosyl(meth)acrylate.

An overview of suitable fluorinated polymers and copolymers is given for example in M. Lewin et al., Chemical Processing of Fibers and Fabrics, Part B, Volume 2, Marcel Dekker, New York (1984), pages 172 ff. and pages 178-182.

Further suitable fluorinated polymers are disclosed for example in DE 199 120 810.

From the group of the olefins having siloxane groups there may be mentioned for example olefins of the general formulae IV a to IV c 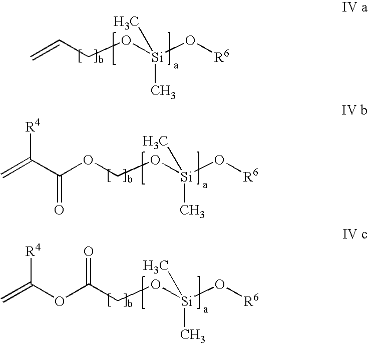
where:
R⁶ is selected from
C₁-C₁₈-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-tetradecyl, n-hexadecyl, n-octadecyl; preferably C₁-C₆-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, more preferably C₁-C₄-alkyl such as methyl, ethyl, n-propyl, isopropyl, n-butyl, isobutyl, sec-butyl and tert-butyl and especially methyl.
C₆-C₁₄-Aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, more preferably phenyl C₃-C₁₂-cycloalkyl, for example cyclopropyl, cyclobutyl, cyclopentyl, cyclohexyl, cycloheptyl, cyclooctyl, cyclononyl, cyclodecyl, cyclodecyl and cyclododecyl, preference is given to cyclopentyl, cyclohexyl and cycloheptyl
or Si(CH₃)₃.
a is an integer in the range from 2 to 10 000 and especially up to 100.
b is an integer in the range from 0 to 6 and especially from 1 to 2.

Useful polymers (a) further include: polyethers such as for example polyethylene glycol, polypropylene glycol, polybutylene glycols, polytetrahydrofuran; polycaprolactone, polycarbonates, polyvinyl butyral,

partly aromatic polyesters formed from aliphatic or aromatic dicarboxylic acids and/or aliphatic or aromatic dialcohols, for example

polyesters formed from aliphatic dialcohols having 2 to 18 carbon atoms such as for example ethylene glycol, 1,3-propanediol, 1,4-butanediol, 1,6-hexanediol, 1,8-octanediol or bisphenol A, and aliphatic dicarboxylic acids having 3 to 18 carbon atoms such as for example succinic acid, glutaric acid, adipic acid and α,ω-decanedicarboxylic acid;

polyesters formed from terephthalic acid and aliphatic dialcohols having 2 to 18 carbon atoms such as for example ethylene glycol propanediol, 1,4-butanediol, 1,6-hexanediol or 1,8-octanediol.

Polyesters mentioned above can be terminated for example with monoalcohols such as for example 4 to 12 carbon atoms, for example n-butanol, n-hexanol, n-octanol, n-decanol or n-dodecanol.

Polyesters mentioned above can be terminated for example with monocarboxylic acids such as for example stearic acid.

Useful polymers (a) further include melamine-formaldehyde resins, urea-formaldehyde resins, N,N-dimethylol-4,5-dihydroxyethyleneureas which may be etherified with C₁-C₅ alcohols.

The molecular weight of the organic polymer or polymers (a) can be selected within wide limits. The weight average molecular weight M_{w} can be in the range from 1000 to 10 000 000 g/mol and preferably in the range from 2500 to 5 000 000 g/mol, determined by at least one of the following methods: light scattering, gel permeation chromatography (GPC), viscometry. When an organic polymer from the group of the polyolefins is used, for example polyethylene, polypropylene or polyisobutylene, and also copolymers of ethylene with propylene, butylene or 1-hexene, the molecular weight will advantageously be in the range from 30 000 to 5 000 000 g/mol.

The width of the molecular weight distribution is not critical as such and can be in the range from 1.1 to 20. It is customarily in the range from 2 to 10.

In one embodiment of the present invention, the fraction of the organic polymer or polymers (a) described above is at least 0.1 g/l of the aqueous liquor, preferably at least 1 g/l and more preferably at least 10 g/l. The maximum fraction is for example 500 g/l, preferably 250 g/l and more preferably 100 g/l.

In one embodiment of the present invention, the organic polymer or polymers (a) are not soluble in the aqueous liquor, not soluble meaning in the context of organic polymers for the purposes of the present invention that at room temperature solubility in the liquor is less than 1 g/l and more preferably less than 0.1 g/l.

One embodiment of the present invention comprises using at least two different organic polymers (a).

In one embodiment of the present invention, at least one organic polymer (a) can be present in the form of particles having an average particle diameter in the range from 0.1 to 50 μm, preferably from 0.5 to 30 μm and more preferably up to 20 μm (median value, number average).

At least one of the aqueous liquor used in the process of the present invention comprises an organic or inorganic solid (b) in particulate form that differs from the organic polymer or polymers (a) described above, for example in a fraction of not less than 5.5 g/l, preferably not less than 7 g/l, more preferably not less than 10 g/l. The maximum fraction can be about 150 g/l. Solid (b) can be inorganic or organic in nature; preferably, it is inorganic. The organic or inorganic solid (b) is preferably hydrophobic.

Examples of suitable materials are polyethylene, polypropylene, polyisobutylene and polystyrene and also copolymers thereof with each other or with one or more further olefins such as for example styrene, methyl acrylate, ethyl acrylate, methyl methacrylate, butyl acrylate, butyl methacrylate, 2-ethylhexyl acrylate, 2-ethylhexyl methacrylate, maleic anhydride or N-methylmaleimide. A preferred polyethylene or polypropylene is described for example in EP-A 0 761 696.

Particularly useful materials include inorganic materials, especially solid inorganic oxides, carbonates, phosphates, silicates or sulfates of groups 3 to 14 of the periodic table, for example calcium oxide, silicon dioxide or aluminum oxide, calcium carbonate, calcium sulfate or calcium silicate, of which aluminum oxide and silicon dioxide are preferred. Particular preference is given to silicon dioxide in its silica gel form. Very particular preference is given to pyrogenic silica gels. Solid inorganic oxides can be hydrophobicized thermally by heating to 400-800° C. or preferably through physisorbed or chemisorbed organic or organometallic compounds. For this, particles are reacted prior to the coating step with, for example, organometallics which comprise at least one functional group, for example alkyllithium compounds such as methyllithium, n-butyllithium or n-hexyllithium; or silanes such as for example hexamethyldisilazane, octyltrimethoxysilane and especially halogenated silanes such as trimethylchlorosilane or dichlorodimethylsilane.

One embodiment of the present invention utilizes a mixture of hydrophobicized solid inorganic oxide with the corresponding nonhydrophobicized inorganic oxide, for example in weight fractions of 100:0 to 0:100, preferably 99:1 to 60:40 and more preferably 99:1 to 80:20.

Hydrophobic in the context of the hydrophobic solid or solids in particulate form is to be understood as meaning that its solubility is below 1 g/l and preferably below 0.3 g/l (determined at room temperature).

Inorganic solids can preferably be porous in nature. The porous structure is best characterized in terms of the BET surface area measured in accordance with German standard specification DIN 66131. Inorganic solids used can preferably have a BET surface area in the range from 5 to 1000 m²/g, preferably in the range from 10 to 800 m²/g and more preferably in the range from 20 to 500 m²/g.

In one embodiment of the present invention, at least one of the hydrophobic solids is present in particulate form. The measure of central tendency particle diameter (median value, number average) is at least 1 nm, preferably at least 3 nm and more preferably at least 6 nm. The maximum particle diameter (median value, number average) is 1000 nm, preferably 350 nm and more preferably 100 nm. The particle diameter can be measured using commonly used methods such as for example transmission electron microscopy.

The weight ratio of organic polymer (a) to organic or inorganic solid (b) in particulate form is generally in the range from 9:1 to 1:9, preferably in the range from 4:1 to 1:4 and more preferably in the range from 7:3 to 4:6.

In one embodiment of the present invention, at least one of the organic or inorganic solids (b) is present in the form of predominantly spherical particles, which language is intended to comprise particulate solids where not less than 75% by weight and preferably not less than 90% by weight is present in spherical form while further particles can be present in granular form.

In one embodiment of the present invention at least one of the organic or inorganic solids (b) in particulate form can form aggregates and/or agglomerates. When one or more organic or inorganic solids (b) are present in the form of aggregates and/or agglomerates, which can consist of from 2 to several thousand primary particles and which in turn can have spherical form, the particulars concerning particle shape and size relate to primary particles.

At least one liquor used in the process of the present invention comprises at least one emulsifier (c) selected for example from the group of ionic and nonionic emulsifiers.

Useful nonionic emulsifiers include for example ethoxylated mono-, di- and trialkylphenols (degree of ethoxylation in the range from 3 to 50, alkyl radical: C₄-C₁₂) and also ethoxylated fatty alcohols (degree of ethoxylation in the range from 3 to 80; alkyl radical: C₈-C₃₆). Examples thereof are the Lutensol® brands from BASF AG or the Triton® brands from Union Carbide.

Useful anionic emulsifiers include for example alkali metal and ammonium salts of alkyl sulfates (alkyl radical: C₈ to C₁₂), of acid sulfuric esters of ethoxylated alkanols (degree of ethoxylation in the range from 4 to 30, alkyl radical C₁₂-C₁₂) and ethoxylated alkylphenols (degree of ethoxylation in the range from 3 to 50, alkyl radical: C₄-C₁₂), of alkylsulfonic acids (alkyl radical: C₁₂-18) and of alkylarylsulfonic acids (alkyl radical: C₉-C₁₈).

Useful cationic emulsifiers are generally C₆-C₁₈-alkyl-, C₆-C₁₈-alkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)-ethyl paraffinic acid esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the Gemini surfactant N,N′-(lauryldimethyl)ethylenediamine dibromide. Numerous further examples may be found in H. Stache, Tensid-Taschenbuch, Carl-Hanser-Veriag, Munich, Vienna, 1981 and in McCutcheon's, Emulsifiers & Detergents, MC Publishing Company, Glen Rock, 1989.

Very particularly suitable emulsifiers include for example copolymers of ethylene and at least one α,β-unsaturated mono- or dicarboxylic acid or at least one anhydride of an α,β-unsaturated mono- or dicarboxylic acid, for example acrylic acid, methacrylic acid, crotonic acid, maleic acid, fumaric acid, methylenemalonic acid, maleic anhydride, itaconic anhydride. The carboxyl groups can be partly or preferably wholly neutralized, for example with alkali metal ions, alkaline earth metal ions, ammonium or amines, for example amines such as triethylamine, diethylamine, ethylamine, trimethylamine, dimethylamine, methylamine, ethyldiisopropylamine, ethanolamine, diethanolamine, triethanolamine, N-methyldiethanolamine, N-(n-butyl)diethanolamine or N,N-dimethyl-ethanolamine.

Very particularly preferred emulsifiers are selected from emulsifiers of the general formula I 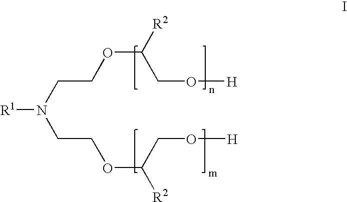
and II 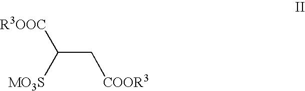
where
R¹ is selected from C₆-C₄₀-alkyl, for example n-hexyl, iso-hexyl, n-heptyl, isoheptyl, n-octyl, isooctyl, n-nonyl, n-decyl, isodecyl, n-undecyl, n-dodecyl, isododecyl, n-tridecyl, n-tetradecyl, isotetradecyl, n-pentadecyl, n-hexadecyl, n-octadecyl, n-eicosyl, n-C₃₀H₆₁, n-C₄₀H₈₁,
   C₃-C₄₀-alkenyl having one to five carbon-carbon double bonds, which carbon-carbon double bonds can be for example isolated or conjugated. Examples which may be mentioned are allyl, —(CH₂)₂—CH═CH₂, all-cis-(CH₂)₈—(CH═CH—CH₂)₃CH₃, all-cis-(CH₂)₈—(CH═CH—CH₂)₂(CH₂)₄CH₃, all-cis-(CH₂)₈—CH═CH—(CH₂)₇CH₃,
R² is at each instance the same or different and selected from hydrogen and methyl, preferably methyl
m and n are the same or different and are each selected from integers in the range from 0 to 10, preferably 1 or 2 and more preferably 2,
R³ is at each instance the same or different and selected from hydrogen and
   C₆-C₂₀-alkyl, for example n-hexyl, isohexyl, n-heptyl, isoheptyl, n-octyl, isooctyl, n-nonyl, n-decyl, isodecyl, n-undecyl, n-dodecyl, isododecyl, n-tridecyl, n-tetradecyl, isotetradecyl, n-pentadecyl, n-hexadecyl, n-octadecyl, n-eicosyl;
M is an alkali metal or ammonium.

The fraction of emulsifier (c) can be chosen within wide limits and can be in the range from 0.1 to 200 g/l, preferably in the range from 0.2 to 100 g/l and more preferably up to 50 g/l of aqueous liquor.

Aqueous liquors used in step (B) may comprise (d) at least one resin capable of crosslinking.

Useful resins (d) include melamine-formaldehyde resins, urea-formaldehyde resins, N,N-dimethylol-4,5-dihydroxyethyleneureas, which may be etherified with C₁-C₅ alcohols.

If it is desired to use one or more resins (d), one or more crosslinking catalysts, examples being Zn(NO₃)₂ or MgCl₂, for example in the form of their hydrates, or NH₄Cl, may be added to aqueous liquor (B) in addition to resin (d).

Aqueous liquors used in step (B) may further comprise one or more extras.

Aqueous liquors used in the process of the present invention may have added to them, to adjust their viscosity, one or more thickeners which can be of natural or synthetic origin for example. Useful synthetic thickeners are poly(meth)acrylic compounds, polycarboxylic acids, polyethers, polyimines, polyamides and polyurethanes, especially copolymers comprising from 85% to 95% by weight of acrylic acid, from 4% to 15% by weight of acrylamide and about 0.01%-1% by weight of the (meth)acrylamide derivative of the formula V 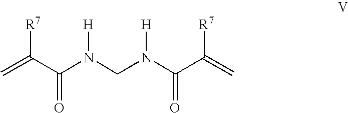
having molecular weights M_{w} in the range from 100 000 to 200 000 g/mol, in each of which R⁷ represents methyl or preferably hydrogen. Thickeners of natural origin include for example agar, carrageenan, modified starch and modified cellulose.

The amount of thickener used can be for example in the range from 0% to 10% by weight, based on liquor used in the process of the present invention preferably in the range from 0.05% to 5% by weight and more preferably in the range from 0.1% to 3% by weight.

Liquors used in the process of the present invention preferably have a room-temperature dynamic viscosity in the range from 50 to 5000 mPa·s preferably in the range from 1100 to 4000 mPa·s and more preferably in the range from 200 to 2000 mPa·s, measured for example using a Brookfield viscometer in accordance with German standard specification DIN 51562 parts 1 to 4.

Step (B) of the process according to the present invention is carried out by treating absorbent material with at least one aqueous liquor. It is also possible to carry out plural treatment steps with identical or different aqueous liquors.

In one embodiment of the present invention, step (B) of the process according to the present invention is carried out by treating absorbent material and especially textile first with an aqueous liquor which comprises at least one organic polymer (a) and further an organic or preferably inorganic solid (b) in particulate form and at least one emulsifier (c) and subsequently with a new aqueous liquor which comprises organic polymer (a) but no further organic or inorganic solid (b) in particulate form.

In another embodiment of the present invention, step (B) of the process according to the present invention is carried out by treating absorbent material and especially textile first with an aqueous liquor which comprises at least one organic polymer (a) and further an organic or preferably inorganic solid (b) in particulate form and at least one emulsifier (c) and optionally at least one resin (d) and subsequently with a new aqueous liquor which comprises another organic polymer (a) and at least one emulsifier (c) but no further organic or inorganic solid (b) in particulate form.

In a specific embodiment of the present invention, step (B) of the process according to the present invention is carried out by treating textile first with an aqueous liquor which comprises at least one organic polymer (a) and further an organic or preferably inorganic solid (b) in particulate form and at least one emulsifier (c) and subsequently with a new aqueous liquor which comprises no further polymer (a) but comprises the inorganic solid (b) in particulate form already used in the first step and at least one emulsifier (c) and optionally at least one resin (d).

Step (B) of the process according to the present invention is preferably carried out by treating absorbent material and especially textile with just one aqueous liquor which comprises at least one organic polymer (a) and further an organic or preferably inorganic solid (b) in particulate form and at least one emulsifier (c) and optionally at least one resin (d).

The temperature at which step (B) of the process according to the present invention is carried out is as such not critical. The liquor temperature can be in the range from 10 to 80° C. and preferably in the range from 15 to 50° C.

Step (B) of the process of the present invention can be carried out with machines commonly used for the finishing of absorbent materials and especially textiles for example one or more pad-mangles. Preference is given to vertical textile feed pad-mangles, where the essential element is two rolls in pressed contact with each other, through which the textile is led. The liquid is filled in above the rolls and wets the textile. The pressure causes the textile to be squeezed off and ensures a constant add-on. In other preferred pad-mangles, textile is first led through a dip bath and then upwardly through two rolls in pressed contact with each other. In the latter case, these are also referred to as pad-mangles with vertical textile feed from below.

One embodiment of the present invention utilizes a pad-mangle operated with a textile feed in the range from 1 to 40 m/min and preferably up to 30 m/min.

Liquor pickup can be chosen such that step (B) the process of the present invention provides a liquor pickup in the range from 25% by weight to 85% by weight and preferably in the range from 40% by weight to 70% by weight. Liquor pickup can be adjusted for example via the squeeze pressure of the rolls of the pad-mangle.

A specific embodiment of the present invention combines foam application of aqueous liquor with a pad-mangle. Another embodiment of the present invention combines a doctor application of aqueous liquor with a pad-mangle. Another embodiment of the present invention combines a spray application of aqueous liquor with a pad-mangle. Another embodiment of the present invention combines a roll application of aqueous liquor with a pad-mangle.

The treated absorbent material and especially textile after the treatment according to this invention can be dried by methods customary in the textile industry.

The treatment according to the present invention can be followed by a heat treatment, which can be operated continuously or batchwise. The duration of the heat treatment can be chosen within wide limits. The heat treatment can typically be carried out for from about 10 seconds to about 30 minutes, especially from 30 seconds to 5 minutes. The heat treatment is carried out by heating to temperatures of up to 180° C., preferably up to 150° C. It is of course necessary to adapt the temperature of the heat treatment to the sensitivity of the fabric.

An example of a suitable method of heat treatment is hot air drying. Another suitable heat-treatment method is to use one or more IR radiators.

In another embodiment, when polyesters or polyamides are to be treated, from 0.01% to 1% by weight and preferably from 0.1 to 0.5% by weight of the textile is saponified by partial saponification with strong alkalis such as aqueous sodium hydroxide solution or potassium hydroxide solution.

The present invention further provides absorbent materials and especially textile finished by the process of the present invention. Finishing according to the present invention provides the present invention's absorbent materials and especially textiles with one or more coats. The present invention's absorbent materials and especially textiles exhibit particularly good soil- and water-repellent performance. The present invention's absorbent materials and especially textiles further exhibit very good mechanical strength. In absorbent materials, and especially textiles, coated according to the present invention, the solid or solids used are preferably isotropically or substantially isotropically dissipated throughout the finishing coat, i.e., no measurable concentration is observed in the boundary layer between the finishing coat and the surrounding atmosphere.

In one embodiment, the present invention's absorbent materials and especially textiles comprise from 0.5 to 50 g/m² of coating resulting from treatment with aqueous liquor, preferably from 1 to 20 g/m² and more preferably from 1.5 to 17 g/m².

The invention is illustrated by examples.

### EXAMPLE 1

### Example 1.1

### Pretreatment of Textiles by Singeing (Step A)

Woven polyacrylonitrile fabric having a basis weight of 300 g/m² was pretreated front and back on a Pyrotrop XIS machine (equipped with 4 burners with propane gas and fire-extinguishing roll) from Xetma Gematex GmbH by leading the fabric east hot ceramic. Settings: linear speed 70 m/min, 6.5 m³/h and burner gas pressure 60 mbar, air consumption 0.01 m³/h.

This gave pretreated polyacrylonitrile fabric 1.1. A test of pretreated polyacrylonitrile fabric 1.1 according to DIN EN 24920 was rated 1, that is, pretreated polyacrylonitrile fabric 1.1 was fully wettable.

To the naked eye, pretreated polyacrylonitrile fabric 1.1 was free of hairs protruding from the leveled plane.

### Example 1.2

### Pretreatment with Copolymer (Step A)

An aqueous dispersion of a copolymer was produced to comprise per liter:
923 g of aqueous dispersion of a random copolymer of n-butyl acrylate/vinyl acetate/acrylic acid in 50:48:2 weight ratio, solids content 50% by weight, dynamic viscosity: 50 mPa·s
5 g of H(OCH₂H₂)₇O—(CH₂)₃—Si[OSi(CH₃)₃]₂
3 g of alkylphenol ethoxylate
25 g of 2-methoxycarbonylaminobenzimidazole
20 g of thickener (copolymer of 85% by weight of acrylic acid, 14.9% by weight of acrylamide and 0.1% by weight of compound V.1, M_{w} about 200 000 g/mol) 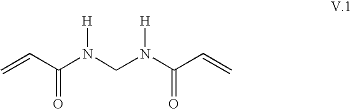
9 g of aqueous ammonia solution (25% by weight)
15 g of melamine-formaldehyde resin prepared by condensation of 3 equivalents of formaldehyde per equivalent of melamine, exhaustively etherified with methanol
12 g of aqueous NH₄Cl solution (20% by weight).

Dynamic viscosity at 25° C.: 130 mPa·s.

The dispersion described above was knifecoated atop woven polyacrylonitrile fabric having a basis weight of 300 g/m², in an amount of 25 g/m². This was followed by drying in a drying cabinet at 160° C. for 2 minutes. Pretreated polyacrylonitrile fabric 1.2 was obtained.

To the naked eye, pretreated polyacrylonitrile fabric 1.2 was free of hairs protruding from the leveled plane.

A test of pretreated polyacrylonitrile fabric 1.2 according to DIN EN 24920 was rated 1; that is, pretreated polyacrylonitrile fabric 1.2 was fully wettable.

### EXAMPLE 2

### Production of Aqueous Liquors

### Example 2.1

### Production of Aqueous Liquor B-2.1

The following were mixed in a flask by mechanical stirring:

624 g of distilled water,

120 g of an aqueous dispersion (30% by weight solids content) of a random copolymer formed from 10% by weight of methacrylic acid and 90% by weight of CH₂═C(CH₃)COO—CH₂—CH₂-n-C₆F₁₃ and having Mₙ 3000 g/mol (gel permeation chromatography).

200 g of an aqueous dispersion (8% by weight solids content) consisting of 135 g of water, 43 g of ethylene glycol mono-n-butyl ether, 16 g of dimethylsiloxane group modified pyrogenic silica having a BET surface area of 225 m²/g, determined according to German standard specification DIN 66131, primary particle size: 10 nm (median value, number average), and 6 g of amine of the formula I.1 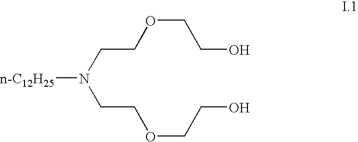
neutralized with 32% by weight of aqueous HCl were added and dispersed for 10 minutes (Ultraturrax stirrer).
56 g of a melamine-formaldehyde resin etherified with methanol (solids content 50%).
8 g of a 20% solution of ammonium chloride.

This gave the aqueous liquor B-2.1, which had a pH of 6.1

### Example 2.2

### Production of Aqueous Liquor B-2.2

The following were mixed in a flask by mechanical stirring:

872.8 g of distilled water,

68.1 g of an aqueous dispersion (20% by weight solids content) of a random copolymer formed from 10% by weight of methacrylic acid and 90% by weight of CH₂═C(CH₃)COO—CH₂—CH₂-n-C₆F₁₃ and having Mₙ 3000 g/mol (gel permeation chromatography),

86.5 g of an aqueous dispersion (20% by weight solids content) of a random copolymer formed from 20% by weight of acrylic acid, 80% by weight of ethylene, M_{w}:

20 000 g/mol, neutralized with N,N-dimethylethanolamine, pH between 8.5 and 9.5, Then 12.8 g of dimethylsiloxane group modified pyrogenic silica having a BET surface area of 225 m²/g, determined in accordance with German standard specification DIN 66131, primary particle size: 10 nm (median value, number average) were added and
8.8 g of amine of the formula I.1 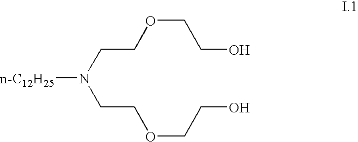
neutralized with 32% by weight aqueous HCl were added and dispersed for 10 minutes (Ultraturrax stirrer) to give the inventive aqueous liquor 7-2.27 which had a pH of 6.5.

### Example 2.3

### Production of Inventive Aqueous Liquor B-2.3

The following were mixed in a flask by mechanical stirring:

872.8 g of distilled water,

68.1 g of an aqueous dispersion (20% by weight solids content) of a random copolymer formed from 10% by weight of methacrylic acid and 90% by weight of CH₂═C(CH₃)COO—CH₂—CH₂-n-C₆F₁₃ and having Mₙ 3000 g/mol (gel permeation chromatography),

86.5 g of an aqueous dispersion (20% by weight solids content) of a random copolymer formed from 20% by weight of acrylic acid, 80% by weight of ethylene, M_{w}:

20 000 g/mol, neutralized with N,N-dimethylethanolamine, pH between 8.5 and 9.5. Then 12.8 g of dimethylsiloxane group modified pyrogenic silica having a BET surface area of 225 m²/g, determined in accordance with German standard specification DIN 66131, primary particle size: 10 nm (median value, number average) were added and
8.8 g of amine of the formula I.2 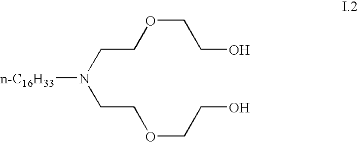
neutralized with 32% by weight of aqueous HCl were added and dispersed for 10 minutes (Ultraturrax stirrer) to give the inventive aqueous liquor B-2.2, which had a pH of 6.5.

### Example 2.4

### Production of Inventive Aqueous Liquor B-2.4

The following were mixed in a flask by mechanical stirring:

872.8 g of distilled water,

68.1 g of an aqueous dispersion (20% by weight solids content) of a random copolymer formed from 10% by weight of methacrylic acid and 90% by weight of CH₂═C(CH₃)COO—CH₂—CH₂-n-C₆F₁₃ and having Mₙ 3000 g/mol (gel permeation chromatography),

86.5 g of an aqueous dispersion (20% by weight solids content of a random copolymer formed from 20% by weight of acrylic acid, 80% by weight of ethylene, M_{w}:

20 000 g/mol, neutralized with N,N-dimethylethanolamine, pH between 8.5 and 9.5. Then 12.8 g of dimethylsiloxane group modified pyrogenic silica having a BEET surface area of 225 m²/g, determined in accordance with German standard specification DIN 66131, primary particle size, 10 nm (median value, number average) were added and
8.8 g of amine of the formula I.2 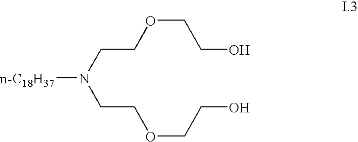
neutralized with 32% by weight of aqueous HCl were added and dispersed for 10 minutes (Ultraturrax stirrer) to give the inventive aqueous liquor B-2.4, which had a pH of 6.7.

### EXAMPLE 3

### Finishing of Pretreated Textile

### Example 3.1

### Treatment with Aqueous Liquor B-2.1

### Example 3.1.1

### Treatment of Pretreated Polyacrylonitrile Fabric 1.1 (Step B)

Pretreated polyacrylonitrile fabric 1.1 was treated with liquor B-2.1 on a pad-mangle from Mathis (model HVF12085). The squeeze pressure of the rolls was 2.6 bar. This resulted in a liquor pickup of 60%. The application speed was 2 m/min. This was followed by drying on a tenter at 120° C. The conclusive heat treatment took 2 min at 160° C. with circulating air in a drying cabinet. The inventive treated polyacrylonitrile fabric PAN3.1.1 was obtained.

### Example 3.1.2

### Treatment of Pretreated Polyacrylonitrile Fabric 1.2 (Step B)

Pretreated polyacrylonitrile fabric 1.2 was treated with liquor B-2.1 on a pad-mangle from Mathis (model HVF12035). The squeeze pressure of the rolls was 2.6 bar. This resulted in a liquor pickup of 60%. The application speed was 2 m/min. This was followed by drying on a tenter at 120° C. The conclusive heat treatment took 2 min at 160° C. with circulating air in a drying cabinet. The inventive treated polyacrylonitrile fabric PAN3.1.2 was obtained.

### Example 3.2

### Treatment with Aqueous Liquor B-2.2

### Example 3.2.1

### Treatment of Pretreated Polyacrylonitrile Fabric 1.1 (Step B)

Pretreated polyacrylonitrile fabric 1.1 was treated with liquor B-2.2 on a pad-mangle from Mathis (model HVF12085). The squeeze pressure of the rolls was 2.6 bar. This resulted in a liquor pickup of 60%. The application speed was 2 m/min. This was followed by drying on a tenter at 120° C. The conclusive heat treatment took 2 min at 160° C. with circulating air in a drying cabinet. The inventive treated polyacrylonitrile fabric PAN3.2.1 was obtained.

### Example 3.2.2

### Treatment of Pretreated Polyacrylonitrile Fabric 1.2 (Step B)

Pretreated polyacrylonitrile fabric 1.2 was treated with liquor B-2.2 on a pad-mangle from Mathis (model HVF12085). The squeeze pressure of the rolls was 2.6 bar. This resulted in a liquor pickup of 60%. The application speed was 2 m/min. This was followed by drying on a tenter at 120° C., The conclusive heat treatment took 2 min at 160° C. with circulating air in a drying cabinet. The inventive treated polyacrylonitrile fabric PAN3.2.2 was obtained.

### Example 3.3

### Treatment with Aqueous Liquor B-2.3

### Example 3.3.1

### Treatment of Pretreated Polyacrylonitrile Fabric 1.1 (Step B)

Pretreated polyacrylonitrile fabric 1.1 was treated with liquor B-2.3 on a pad-mangle from Mathis (model HVF12085). The squeeze pressure of the rolls was 2.6 bar. This resulted in a liquor pickup of 60%. The application speed was 2 m/min. This was followed by drying on a tenter at 120° C. The conclusive heat treatment took 2 min at 160° C. with circulating air in a drying cabinet. The inventive treated polyacrylonitrile fabric PAN3.3.1 was obtained.

### Example 3.3.2

### Treatment of Pretreated Polyacrylonitrile Fabric 1.2 (Step B)

Pretreated polyacrylonitrile fabric 1.2 was treated with liquor B-2.3 on a pad-mangle from Mathis (model HVF12085). The squeeze pressure of the rolls was 2.6 bar. This resulted in a liquor pickup of 60%. The application speed was 2 m/min. This was followed by drying on a tenter at 120° C. The conclusive heat treatment took 2 min at 160° C. with circulating air in a drying cabinet. The inventive treated polyacrylonitrile fabric PAN3.3.2 was obtained.

### Example 3.4

### Treatment with Aqueous Liquor B-2.4

### Example 3.4.1

### Treatment of Pretreated Polyacrylonitrile Fabric 1.1 (Step B)

Pretreated polyacrylonitrile fabric 1.1 was treated with liquor B-2.4 on a pad-mangle from Mathis (model HVF12085). The squeeze pressure of the rolls was 2.6 bar. This resulted in a liquor pickup of 60%. The application speed was 2 m/min. This was followed by drying on a tenter at 120° C. The conclusive heat treatment took 2 min at 160° C. with circulating air in a drying cabinet. The inventive treated polyacrylonitrile fabric PAN3.4.1 was obtained.

### Example 3.4.2

### Treatment of Pretreated Polyacrylonitrile Fabric 1.4 (Step B)

Pretreated polyacrylonitrile fabric 1.2 was treated with liquor B-2.4 on a pad-mangle from Mathis (model HVF12085). The squeeze pressure of the rolls was 2.6 bar. This resulted in a liquor pickup of 60%. The application speed was 2 m/min. This was followed by drying on a tenter at 120° C. The conclusive heat treatment took 2 min at 160° C. with circulating air in a drying cabinet. The inventive treated polyacrylonitrile fabric PAN3.4.2 was obtained.

### COMPARATIVE EXAMPLES

### Comparative Example V4

Woven polyacrylonitrile fabric having a bases weight of 300 g/m² was treated with liquor B-2.1 on a pad-mangle from Mathis (model HVF12085). The squeeze pressure of the rolls was 2.6 bar. This resulted in a liquor pickup of 60%. The application speed was 2 ml/min. This was followed by drying on a tenter at 120° C. The conclusive heat treatment took 2 min at 160° C. with circulating air in a drying cabinet. Comparative fabric V4 was obtained.

### Comparative Example V5

An aqueous liquor V5.1 was produced by diluting 68.1 g of an aqueous dispersion (20% by weight solids content) of a random copolymer formed from 10% by weight of methacrylic acid and 90% by weight of CH₂═C(CH₃)COO—CH₂—CH₂-n-C₆F₁₃ and having Mₙ 3000 g/mol (gel permeation chromatography) with distilled water to one liter.

Woven polyacrylonitrile fabric having a basis weight of 300 g/m² was treated with liquor V5.1 on a pad-mangle from Mathis (model HVF12085). The squeeze pressure of the rolls was 2.6 bar. This resulted in a liquor pickup of 60%. The application speed was 2 m/min. This was followed by drying on a tenter at 120° C. The conclusive heat treatment took 2 min at 160° C. with circulating air in a drying cabinet. Comparative fabric V5 was obtained.

### EXAMPLE 4

### Performance Testing of Textile Samples Treated According to Invention and of Comparative Fabrics V4 and V5

The polyacrylonitrile fabrics treated according to the invention and the comparative fabrics to be tested were each manually tensioned and fixed with nails to a flat wooden board whose inclination was continuously adjustable in the range from 1° to 90°. A cannula was then used to drip individual water droplets from a height of 10 mm onto the polyacrylonitrile fabric treated according to the present invention. The droplets had a mass of 4.7 mg. The angle of inclination was reduced in stages to that angle of inclination at which the droplets were just starting to be beaded off and there was no sign of adhesion. The results are to be found in table 1.

Water uptake after 60 minutes and 24 hours was determined by determining fabric weight before and after the one- or 24-hour immersion of a fabric sample in completely ion-free water and also tested according to Bundesmann, DIN 53888.

Table 1: Performance properties of polyacrylonitrile fabrics finished according to invention or not

| | | | PAN3.1.1 | PAN3.1.2 |
|---|---|---|---|---|
| Test method | V4 | V5 | (inventive) | (inventive) |
| Self-cleaning to | 3-4 | 2 | 5 | 5 |
| DIN 24920 [rating] | | | | |
| Angle of | 7 | 12 | 6 | 6 |
| inclination [°] | | | | |
| Hand | soft | harsh | soft | harsh |
| Wrinkling | little | little | little | very little |
| Water uptake | 27% by | 55% by | 23% by | 19% by |
| after 60 minutes | weight | weight | weight | weight |
| Water uptake | 62% by | 69% by | 42% by | 57% by |
| after 60 minutes | weight | weight | weight | weight |
| Water uptake | | | | |
| to Bundesmann: | | | | |
| Rating | 4-5 | 4-5 | 5 | 5 |
| Water uptake | 17.7% | 23.3% | 8.4% | 11.5% |
| Perviousness | 0 | 0 | 0 | 0 |

Self-cleaning was tested on the lines of German standard specification DIN 24920 by treating the respective fabric with 0.5 g of a standard soil, consisting of 50% by weight of silica, 24% by weight of olive oil, 24% by weight of mineral oil and 2% by weight of carbon black, and then washing it down with 800 ml of water. The amount of soil remaining was rated (1: very poor, 2: poor, 3: adequate, 4: satisfactory 5: good).

Hand and wrinkling were determined by a team of judges.

1. A process for finishing an absorbent material comprising
(A) hydrophilicizing said material in a first step, and
(B) treating said material in a subsequent step with at least one aqueous liquor comprising
(a) at least one organic polymer,
(b) at least one organic or inorganic solid in particulate form other than (a) and
(c) at least one emulsifier.

2. The process according to claim 1 wherein step (A) comprises contacting said absorbent material with one or more objects having a temperature of not less than 450° C. or with one or more flames.

3. The process according to claim 2 wherein said object having a temperature of not less than 450° C. is a glowing plate of copper.

4. The process according to claim 1 wherein step (A) comprises leading said absorbent material past one or more ceramic bodies having a temperature in the range of from 800 to 1300° C.

5. The process according to claim 1 wherein step (A) comprises treating said absorbent material with at least one melt or dispersion of at least one (co)polymer selected from anionic polyurethanes, copolymers of C₁-C₁₀-alkyl (meth)acrylates and copolymers of C₁-C₁₀-alkyl(meth)acrylates with at least one ethylenically unsaturated compound.

6. The process according to claim 5 wherein step (A) comprises applying at least one (co)polymer in a layer thickness in the range of from 10 to 500 μm atop said absorbent material.

7. The process according to claim 1 wherein the or at least one of said organic or inorganic solids (b) is hydrophobic.

8. The process according to claim 1 wherein said at least one aqueous liquor (B) also comprises
(d) at least one resin capable of crosslinking.

9. The process according to claim 1 wherein said organic or inorganic solid or solids (b) have a particle diameter (median value, number average) in the range of from 10 to 1000 nm.

10. The process according to claim 1 wherein said absorbent material comprises textile material.

11. The process according to claim 1 wherein said absorbent material comprises material composed of polyacrylonitrile, polyester or cotton.

12. The process according to claim 1 wherein said at least one emulsifier (c) is selected from emulsifiers of general formula I 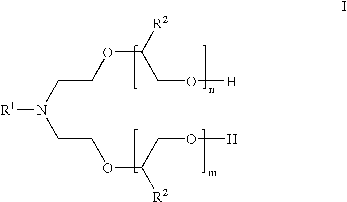
and II 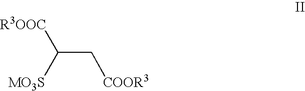
wherein
R¹ is selected from C₆-C₄₀-alkyl and C₃-C₄₀-alkenyl having one to five carbon-carbon double bonds.
R² is at each instance the same or different and selected from hydrogen and methyl,
m and n are the same or different and each selected from integers in the range of from 0 to 10,
R³ is at each instance the same or different and selected from hydrogen and C₆-C₂₀-alkyl, and
M is an alkali metal or ammonium.

13. An absorbent material finished by a process according to claim 1.
